(19) United States
(12) Patent Application Publication
(10) Pub. No.: US 2017/0049081 A1
(43) Pub. Date: Feb. 23, 2017

(54) OVERFLOW DRAIN APPARATUS

(71) Applicant: Nicola Gandini, Valeggio sul Mincio (Verona) (IT)

(72) Inventor: Nicola Gandini, Valeggio sul Mincio (Verona) (IT)

(21) Appl. No.: 15/240,699

(22) Filed: Aug. 18, 2016

Related U.S. Application Data
(60) Provisional application No. 62/207,683, filed on Aug. 20, 2015.

(51) Int. Cl. A01K 63/00

(52) U.S. Cl. CPC A01K 63/006

(57) ABSTRACT

An overflow drain apparatus for a fluid tank is provided and includes an outer housing, a drain and a plurality of fluid inlets, a lower inner housing, and an upper inner housing, wherein both housings are positioned inside the outer housing, and wherein the housings result in the formation of a plurality of fluid flow paths through the outer housing to allow fluid to be evacuated from the tank from the plurality of fluid flow paths while maintaining a predefined surface level.

### CROSS-REFERENCE TO RELATED APPLICATION

The present application claims priority to and the benefit of U.S. Provisional Application No. 62/207,683, filed Aug. 20, 2015, the entire contents of which are incorporated by reference herein.

### BACKGROUND

In the aquarium industry, due to the biological activities of fish, invertebrates, plants, and micro and macro fauna, tank water tends to include debris and organic substances that can accumulate and make the water ill-suited to the survival of the aquarium's biological organisms. To improve water quality, aquariums can be equipped with various types of filtration equipment (e.g., biological filters, trickling filters, mechanical filters and UV filters) designed to treat the water. This filtration equipment, in the case of smaller aquariums, can be placed directly inside the tank. More sophisticated systems are equipped with external filters.

External filters can be positioned in a cabinet beneath the aquarium tank, or in a separate room. Such external filters can be connected to the aquarium using a pipe that is put under pressure by a pump. Water is drawn out of the aquarium, treated by the filter, and sent back to the aquarium. The removal of water from the aquarium must be regulated, such that appropriate water levels are maintained in the tank. Drain apparatuses can be utilized to manage the water levels.

### SUMMARY

In an embodiment, a drain apparatus comprises an outer housing including a drain, a lower fluid inlet, a middle fluid inlet, and an upper fluid inlet, arranged in that order from a lower portion of the outer housing. The drain apparatus also comprises a weir provided in the outer housing that includes a lower weir end positioned between the lower and middle fluid inlets and an upper weir end positioned between the middle and upper fluid inlets. The weir is configured to divide an interior of the outer housing into a plurality of flow paths including: a main fluid flow path in a primary chamber of the outer housing from the lower fluid inlet to the drain, and a secondary fluid flow path in a secondary chamber of the outer housing from the middle fluid inlet, over the upper weir end, and down to the primary chamber.

In an embodiment, the drain apparatus further comprises a lower inner housing positioned below the lower weir end and formed inside the outer housing. The lower inner housing has an inner fluid inlet at least partially alignable with the lower fluid inlet of the outer housing. The primary chamber is formed inside the lower inner housing, such that when the inner fluid inlet of the lower inner housing is at least partially aligned with the lower fluid inlet of the outer housing the main fluid flow path extends from the lower fluid inlet, to the inner fluid inlet, through the lower inner housing, and to the drain.

In an embodiment, the weir forms an upper inner housing arranged inside the outer house and in fluid communication with the lower inner housing. In this embodiment, the upper inner housing is configured such that the secondary fluid flow path extends from the middle fluid inlet, over the upper weir end into an interior of the upper inner housing, and down to the primary chamber.

In an embodiment, the drain apparatus further comprises a flange disposed between the lower inner housing and the upper inner housing, and between the lower and middle fluid inlets.

In an embodiment, a cross-sectional area of the upper inner housing is less than a cross-sectional area of the lower inner housing.

In an embodiment the upper inner housing is coupled with the lower inner housing via the flange.

In an embodiment, the outer housing is rotatably coupled with the lower inner housing.

In an embodiment, the drain apparatus further comprises a pipe connected to the outer housing at the upper fluid inlet, the pipe including an elbow projecting downward that includes a pipe fluid inlet. In this embodiment, the pipe is configured to produce a siphoning effect when a level of a fluid surrounding the drain apparatus is at least as high as the pipe fluid inlet.

In an embodiment, at least one of the outer housing and the lower inner housing includes at least one blocking member extending across and dividing the inner fluid inlet and lower fluid inlet into a plurality of inlet portions, respectively.

In an embodiment, the middle fluid inlet comprises a plurality of slits positioned around the entire perimeter of the outer housing.

In an embodiment, the outer housing is rotatably coupled to the lower inner housing, and the positions of the lower fluid inlet and the inner fluid inlet are arranged so that the inner fluid inlet can be at least partially covered by the outer housing when the outer housing is rotated with respect to the lower inner housing.

In an embodiment, the drain apparatus further comprises a sensor configured to detect fluid flow information of the drain apparatus and a controller operably connected to the sensor, the controller configured to receive the fluid flow information, and to and to cause the outer housing and the lower inner housing to move relative to one another based on the fluid flow information.

In an embodiment, the drain apparatus further comprises a blocking member positioned inside and rotatably coupled with the lower inner housing so that the inner fluid inlet may be at least partially obstructed by the blocking member.

In an embodiment, the blocking member includes an elongated portion that extends up through an upper end of the outer housing.

In an embodiment, the drain apparatus further comprises: a motor operably coupled to the elongated portion of the blocking member, a sensor configured to detect fluid flow information of the drain apparatus, and a controller operably connected to the sensor and to the motor, the controller configured to receive the fluid flow information and to cause the motor to rotate the blocking member based on the fluid flow information.

In an embodiment, the upper inner housing and the outer housing are concentrically arranged pipes, and a diameter of the upper inner housing is less than a diameter of the outer housing so that an annular fluid flow region exists therebetween, and which is part of the secondary fluid flow path in the secondary chamber.

Additional features and advantages are described herein, and will be apparent from the following Detailed Description and the Figures.

### BRIEF DESCRIPTION OF THE FIGURES

FIG. 1 is a cross sectional view of an embodiment of a drain apparatus.

FIG. 2 is a cross sectional view of an embodiment of a drain apparatus comprising an inner housing and a weir that are concentrically arranged within an outer housing.

FIG. 3A is a cross sectional view of an embodiment of a drain apparatus, where an upper inlet of the outer housing includes a pipe with a downward-facing pipe inlet.

FIG. 3B is an enlarged partial cross sectional view of the drain apparatus shown in FIG. 3A.

FIG. 4 is a cross sectional view of an embodiment of a drain apparatus including a blocking member positioned inside the lower inner housing.

FIG. 5 is a cross sectional view of an embodiment of a drain apparatus comprising a lower inner housing and an upper inner housing that are concentrically arranged within an outer housing, and the drain apparatus is arranged in a PVC plate.

FIG. 6A is a partial three-dimensional view of an embodiment of a drain apparatus, where the outer housing includes blocking members.

FIG. 6B is an enlarged partial three-dimensional view of the drain apparatus shown in FIG. 6A.

FIG. 7 is a three-dimensional view of the outer housing of an embodiment of a drain apparatus.

FIG. 8 is a three-dimensional view of an embodiment of a partially assembled drain apparatus housed within an aquarium tank, the drain apparatus including the upper inner housing, the lower inner housing, the lower fluid inlet, and the middle fluid inlet.

FIG. 9 is a three-dimensional view of the embodiment shown in FIGS. 7 and 8, where the drain apparatus is fully assembled, and includes the outer housing attached to the remainder of the apparatus.

FIG. 10 is a rotated three-dimensional view of the embodiment shown in FIGS. 7 to 9, where the security water flow through the middle fluid inlet is shown.

FIG. 11A is a three-dimensional view of an embodiment of a drain apparatus, where the outer housing includes blocking members at the lower fluid inlet and middle fluid inlet.

FIG. 11B is a three-dimensional view of an embodiment of a drain apparatus.

FIG. 12 is an enlarged partial three-dimensional view of an embodiment of the drain apparatus, where the outer housing includes blocking members and a pipe.

### DETAILED DESCRIPTION

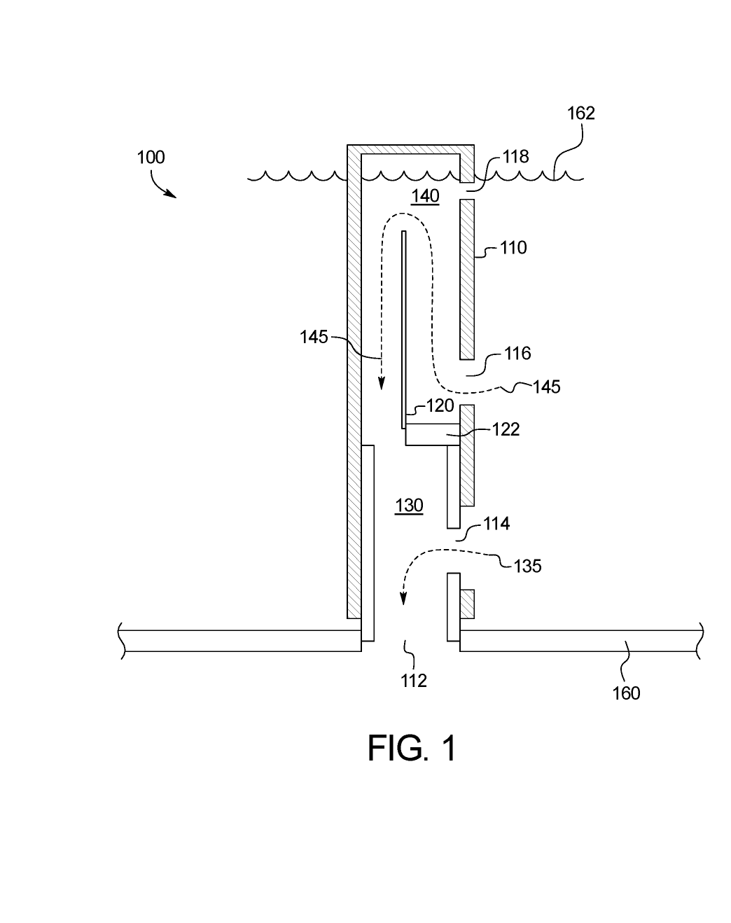

FIG. 1 shows an embodiment of a drain apparatus comprising a housing, and a weir situated in the housing. The drain apparatus 100 includes a housing 110 and a weir 120. The housing 110 has multiple fluid inlets and outlets, including a drain 112, a lower fluid inlet 114, a middle fluid inlet 116, and an upper fluid inlet 118. In other embodiments, the housing 110 may have any number of fluid inlets or outlets that are suitable for a particular use as a drain or fluid evacuation system.

The weir 120 is positioned inside the housing 110. A lower end of the weir 120 is positioned between the lower fluid inlet 114 and the middle fluid inlet 116 so that the housing 110 is divided into two chambers including a primary chamber 130 and a secondary chamber 140. A main fluid flow path 135 in the primary chamber 130 extends from the lower fluid inlet 114 to the drain 112, and a secondary fluid flow path 145 extends from the middle fluid inlet 116, over the upper end of the weir 120, and down to the primary chamber 130.

In this embodiment, the weir 120 extends across the entire width of the housing 110. In one embodiment, the weir 120 is fixed to the housing 110. Alternatively, the weir 120 is removably coupled to the housing 110.

A flange 122 is positioned at the lower end of the weir 120. The flange 122 can be any suitable member that prevents direct fluid flow downward into the primary chamber 130 from the middle fluid inlet 116. Thus, the weir 120 and the flange 122 are structurally configured to require fluids flowing in through the middle fluid inlet 116 to flow into the secondary chamber 140, and over an upper end of the weir 120 before continuing down the secondary fluid flow path 145 toward the primary chamber 130. It should be appreciated that the flange 122 may be integrated with either the housing 110 or the weir 120. Alternatively, the flange 122 is a separate component from the housing 110 and the weir 120.

In operation, the drain apparatus 100 is placed inside a tank 160 containing a fluid. In one example, the tank 160 is an aquarium that contains water. In normal operation, the fluid flows through the lower fluid inlet 114 into the primary chamber 130, and then out through the drain 112. As an example, the fluid will flow through the drain 112 to an external tank (not shown) where filtering is performed, after which the treated fluid is returned to the tank 160. In one example, the flow rate of fluid into the lower fluid inlet 114 is controlled by adjusting the size of the lower fluid inlet 114, which is discussed in further detail below. In this regard, a smaller opening of the lower fluid inlet 114 will throttle or limit the drainage to a desired rate. It should be appreciated that any other suitable method of controlling the main fluid flow into the lower fluid inlet 114 may be used. In one embodiment, the fluid flow capacity of the drain 112 is greater than the fluid flow capacity through the lower fluid inlet 114. This allows for additional drainage through the drain 112 when a secondary fluid flow begins flowing over the weir 120 through the secondary fluid flow path 145, as described in further detail below.

As shown in FIG. 1, if the fluid level 162 in the tank 160 rises above the level of the middle fluid inlet 116, the fluid will begin filling the secondary chamber 140. The surface level of the fluid inside the secondary chamber 140 will approximately correspond to a surface level 162 of the fluid outside the outer housing 110.

In the event that the surface level of the fluid in the secondary chamber 140 rises above the upper end of the weir 120, the fluid will begin to flow over the upper end of the weir 120. This overflow enables an increase in the flow of fluid through the drain 112, through utilization of the secondary fluid flow path 145. The flow from the primary fluid flow path 135 and the secondary fluid flow path 145 combine in the primary chamber 130 and are discharged through the drain 112. Therefore, when the inflow of fluid into the tank 160 exceeds the set inflow capacity of the lower fluid inlet 114 via the primary fluid flow path 135, the water level of the tank will initially rise, until fluid begins to flow down to the drain 112 via the secondary fluid flow path 145. Thus, the secondary fluid flow over the weir 120 and through the secondary chamber 140 functions as a security drain for the aquarium by maintaining the surface level of the water in the tank at approximately the same height as the upper end of the weir 120.

In certain situations, the surface level of the fluid 162 in the tank 160 may rise further, above the upper end of the weir 120, as shown, for example, in FIGS. 1, 2 and 3B. In this situation, fluid flows through the upper fluid inlet 118. Flow through the upper fluid inlet 118 will increase the flow of fluid over the upper end of the weir 120 and through the drain 112 by utilization of the secondary fluid flow path 145. If the surface level of the fluid rises to the point that the upper fluid inlet 118 is completely covered by fluid, air contained in the secondary chamber 140 may be evacuated along the secondary fluid flow path 145. This evacuation, referred to as siphoning, can serve to temporarily increase the fluid flow in the secondary fluid flow path 145, resulting in rapid lowering of the surface of the fluid to an equilibrium state, which is the level established by the upper end of the weir 120.

Thus, referring to FIG. 1, there are three general fluid flow rate scenarios: (1) fluid flow through the main fluid flow path 135, but no fluid flow through the secondary fluid flow path 145 (i.e., the external fluid level is below the upper end of the weir 120); (2) fluid flow through the main fluid flow path 135, and relatively slow fluid flow through the secondary fluid flow path 145 (i.e., the external fluid level is above the upper end of the weir 120); and (3) fluid flow through the main fluid flow path 135, and relatively fast fluid flow through the secondary fluid flow path 145 due to the siphoning effect (i.e., the external fluid level is at or above the upper fluid inlet 118).

In alternative embodiments of the drain apparatus 100, the level of the upper end of the weir 120 is adjustable in order to change the level at which the surface level of the fluid will begin to flow over the upper end of the weir 120 to initiate security draining. The weir 120 may be adjustable upwards or downwards, depending on a particular application of the drain apparatus 100.

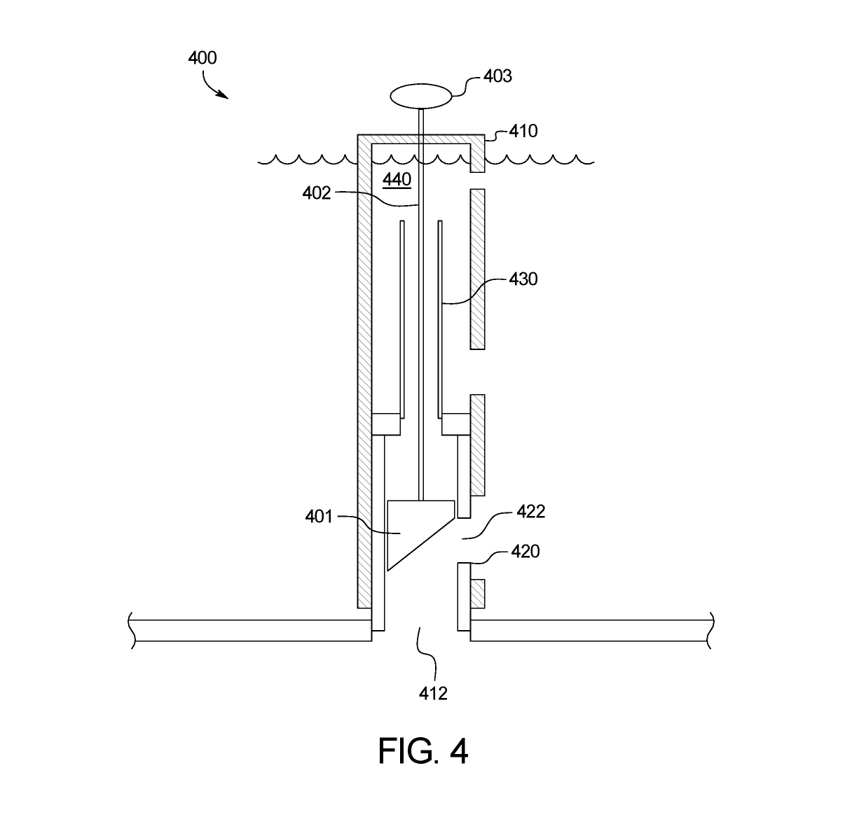

In some embodiments, one or more of the lower fluid inlet 114, the middle fluid inlet 116, and the upper fluid inlet 118 include blocking members (see e.g., FIGS. 4, 6A, 6B, 11A and 12) that are formed across at least one fluid inlet of the outer housing 110. The blocking members enable the flow of a fluid through the respective fluid inlets while blocking foreign objects (e.g., small particles, pebbles, etc.) from entering into the drain apparatus 100 and blocking the drain 112, and/or damaging the drain apparatus 100.

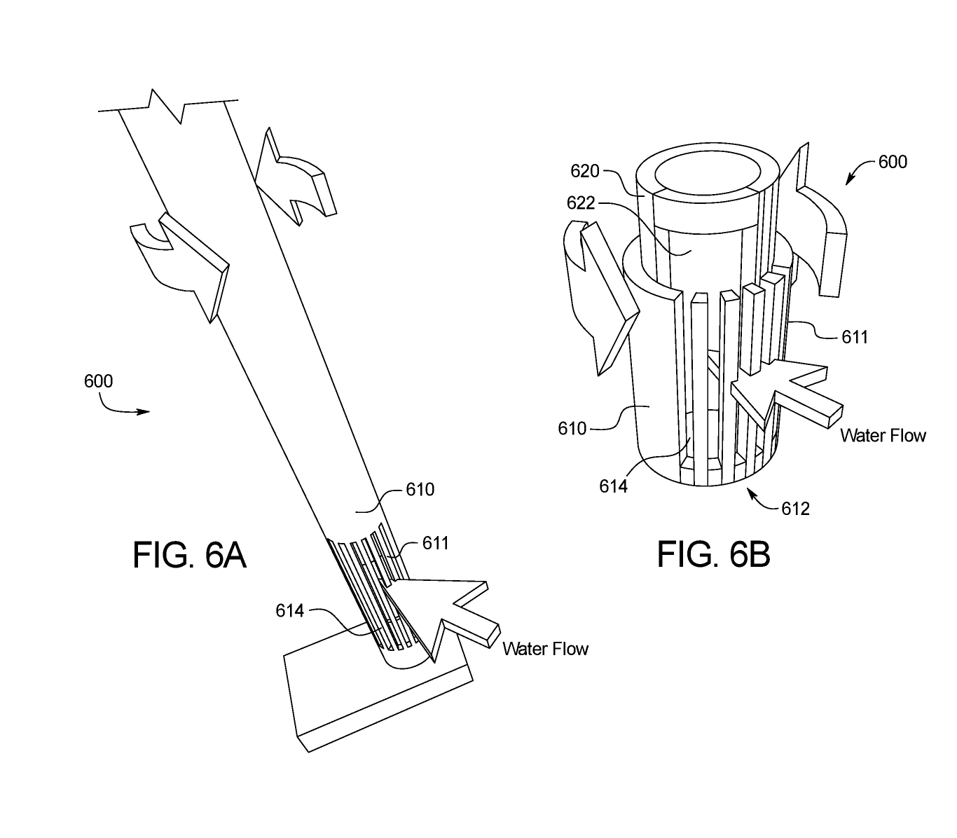

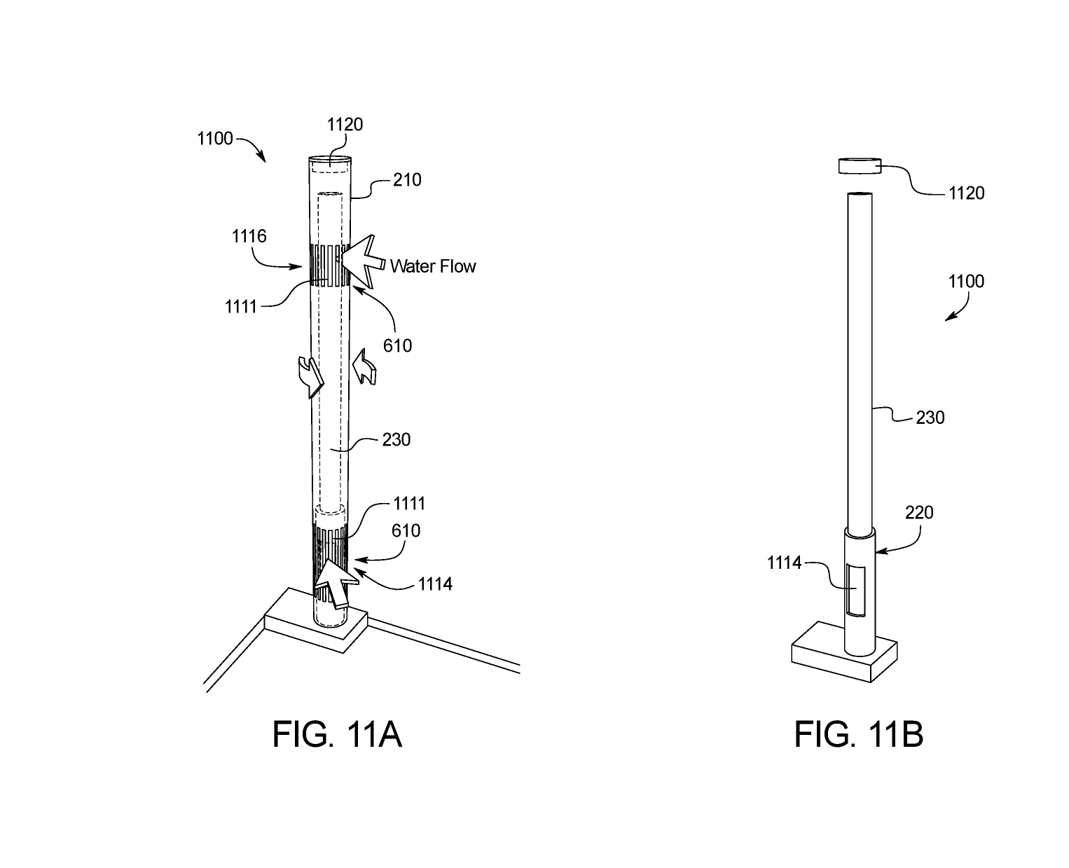

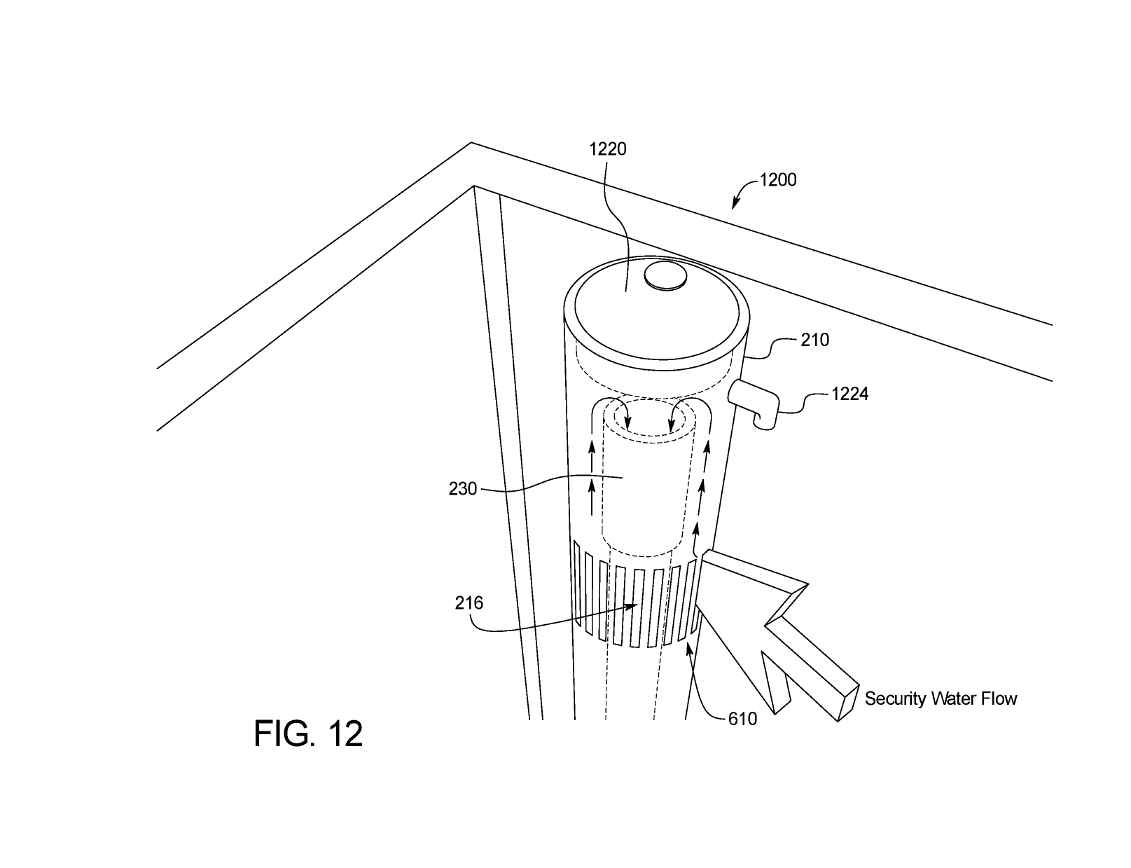

In one example, as shown in FIG. 6A, the blocking members 611 are ribs formed in the outer housing 610 and extending across the lower fluid inlet 614. In another example, as shown in FIG. 11A, the blocking members 1111 extend across both the lower fluid inlet 1114 and the upper fluid inlet 1116. The blocking members can thus enable the restriction of fluid flow rates by covering up a portion of the respective fluid inlets.

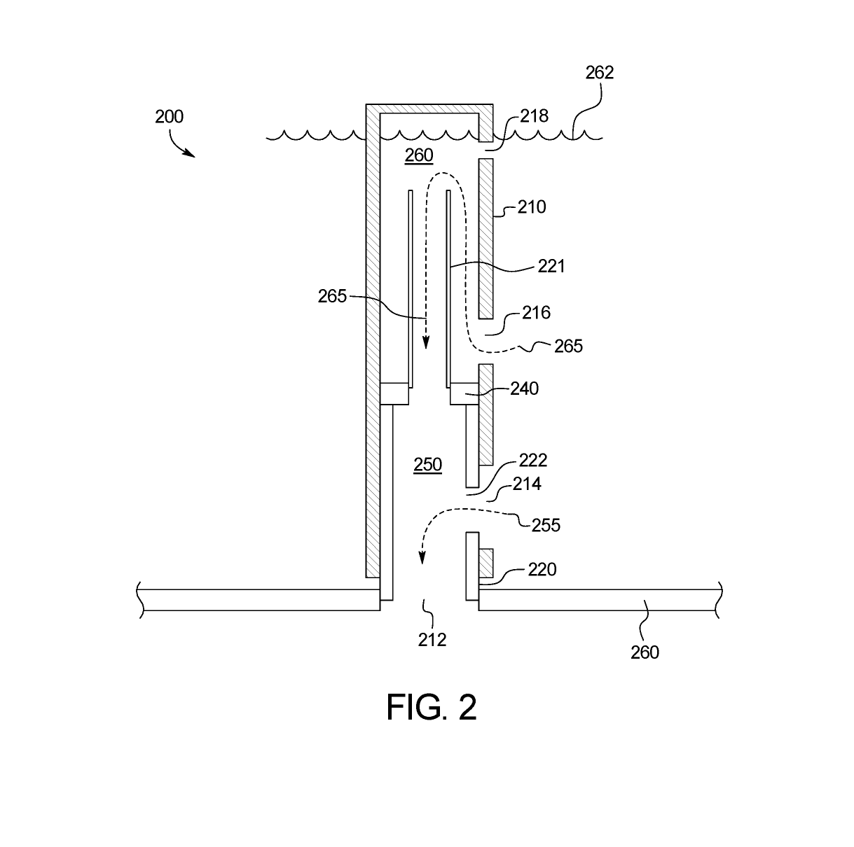

In the example embodiment shown in FIGS. 6A and 6B, the outer housing 610 is rotatable with respect to the inner lower housing 620. Another example of this rotational capability is shown in FIG. 11A. Thus, referring to FIGS. 6A and 6B, if the outer housing 610 is rotated so that the lower fluid inlet 614 having the associated blocking members 611 is not aligned with the inner fluid inlet 622, fluid flow of the main fluid flow path 255 (see, FIG. 2) would stop. In this example, even if the main fluid flow were stopped in this manner, fluid flow would still be possible through the secondary fluid flow path 265 (see, FIG. 2). It should be appreciated that the outer housing 610 may be rotated relative to the inner lower housing 620 (or vice versa) such that only a portion of the blocking members 611 cover the inner fluid inlet 622

FIG. 2 shows an embodiment of a drain apparatus 200 comprising an outer housing and two inner housings. The drain apparatus 200 includes an outer housing 210, a lower inner housing 220, and an upper inner housing 221 (e.g., a weir). The outer housing 210 has multiple fluid inlets, including a drain 212, a lower fluid inlet 214, a middle fluid inlet 216, and an upper fluid inlet 218. It should be appreciated that in other embodiments, additional fluid inlets and outlets may be included.

The lower inner housing 220 and the upper inner housing 221 are situated inside of the outer housing 210, and are in fluid communication with one another. In some embodiments, the diameter and cross-sectional area of the upper inner housing 221 may be less than the diameter and cross-sectional area of the lower inner housing 220. In other embodiments, the upper inner housing 221 and the lower inner housing 220 may have the same cross-sectional area.

In the embodiment shown in FIG. 2, the lower inner housing 220 is positioned above the drain 212 in such a way that it circumscribes the lower interior of the outer housing 210 between the drain 212 and the middle fluid inlet 216. The lower inner housing 220 also has an inner fluid inlet 222 that is alignable with the lower fluid inlet 214 of the outer housing 210. As mentioned above, the lower fluid inlet 214 of the outer housing 210 may be partially blocked with blocking members (see e.g., FIGS. 6A and 6B) that are formed into the outer housing 210.

The lower end of the upper inner housing 221 is positioned between the lower fluid inlet 214 and the middle fluid inlet 216. In the embodiment shown in FIG. 2, the drain apparatus 200 includes a flange 240 that is disposed between the upper inner housing 221 and the lower inner housing 220, and that is positioned between the lower fluid inlet 214 and the middle fluid inlet 216. By utilizing the flange 240 in combination with the upper inner housing 221 (e.g., the weir), the interior of the outer housing 210 is divided into two chambers, a primary chamber 250 and a secondary chamber 260. The lower inner housing 220 circumscribes the primary chamber 250. A main fluid flow path 255 in the primary chamber 250 extends from the lower fluid inlet 214, through the inner fluid inlet 222, to the drain 212. A secondary fluid flow path 265 extends from the middle fluid inlet 216, over the upper end of the upper inner housing 221, into the interior of the upper inner housing 221, and down to the primary chamber 250.

In operation, the drain apparatus 200 is placed inside a tank containing a fluid, for example, an aquarium that contains water. In normal operation, the fluid flows through the lower fluid inlet 214 and the inner fluid inlet 222, into the primary chamber 250, and then out through the drain 212. As an example, the fluid will flow through the drain 212 to an external tank where filtering is performed, after which the treated fluid is returned to the tank 260.

The fluid may also flow through the middle fluid inlet 216 to begin filling the secondary chamber 260. The surface level of the fluid inside the secondary chamber 260 will correspond to the surface level 262 of the fluid outside the outer housing 210 in the tank 260. In the event the surface level of the fluid rises above the upper end of the upper inner housing 221, the fluid will begin to flow over the upper end of the upper inner housing 221 (e.g., the weir), into the interior of the upper inner housing 221. As shown in the example embodiment of FIG. 2, the upper inner housing 221 is a tube that is arranged coannularly with the tubular outer housing 210 and the tubular lower inner housing 220. This overflow into the interior of the upper inner housing 221 functions as a security drain for the aquarium by maintaining the surface level of the water in the tank 260 at approximately the same height as the upper end of the upper inner housing 221. This overflow likewise increases the flow of fluid through the drain 212 by utilization of the secondary fluid flow path 265.

In certain situations, the surface level of the fluid may rise further above the upper end of the upper inner housing 221. In this situation, fluid may flow through the upper fluid inlet 218. Flow through the upper fluid inlet 218 will increase the flow of fluid over the upper end of the upper inner housing 221 and through the drain 212 by utilization of the secondary fluid flow path 265. If the surface level of the fluid rises to the point that the upper fluid inlet 218 is completely covered by fluid, air contained in the secondary chamber 260 will be evacuated along the secondary fluid flow path 265. This evacuation, referred to as siphoning, can serve to temporarily increase the fluid flow in the secondary fluid flow path 265, resulting in rapid lowering of the surface level 262 of the fluid to an equilibrium state, which is the level established by the upper end of the upper inner housing 221.

It should be appreciated that the outer housing 210, the lower inner housing 220, and the upper inner housing 221 can have any suitable shape that allows the flow of fluid into and around the drain apparatus 200 as described above. In some embodiments, the outer housing 210, lower inner housing 220, and upper inner housing 221 are pipes with circular cross sections. Alternatively, the pipes may have any shaped cross section, including but not limited to triangular, square, hexagonal and octagonal.

In some embodiments, the lower fluid inlet 214, middle fluid inlet 216, and upper fluid inlet 218 include blocking members (see, FIG. 6A). The blocking members have the same structure and function as described above with reference to FIGS. 6A and 6B.

In other embodiments, the upper inner housing 221 is telescopically engaged with the lower inner housing 220. This allows the upper inner housing 221 to be moved up and down and thereby adjust the level of the upper end of the upper inner housing 221. This may be done in order to change the level at which the surface level of the fluid will begin to overflow into the upper inner housing 221 and initiate security draining. The upper inner housing 221 may be adjustable upwards or downwards, depending on a particular application of the drain apparatus 200.

According to one alternative embodiment of the drain apparatus 200, the outer housing 210 is telescopically engaged with the lower inner housing 220 so that fluid flow through the inner fluid inlet 222 may be regulated. By moving the outer housing 210 upwards or downwards, the opening of the inner fluid inlet 222 is partially blocked by the outer housing 210, thereby limiting the amount of fluid entering through the inner fluid inlet 222. Thus, the non-ribbed outer housing 210 can function in a similar blocking manner as the blocking members 611 discussed with regard to FIGS. 6A and 6B, one difference being that the blocking in this example is accomplished with a upward and downward movement of the outer housing 210, whereas in FIG. 6A it is accomplished with a rotational movement of the outer housing 210. The outer housing 210 may be moved upwards or downwards until the inner fluid inlet 222 is completely blocked by the outer housing 210, thereby cutting off the flow of fluid through the inner fluid inlet 222. The adjustment of flow through the inner fluid inlet 222, including controlling the size of the inner fluid inlet 222, may be based on a particular application of the drain apparatus 200, such as the particular needs of a tank in which drain apparatus 200 is operating.

According to another embodiment of the drain apparatus 200, the outer housing 210 is rotatably coupled to the lower inner housing 220. In this embodiment, the fluid flow through the inner fluid inlet 222 can be regulated by the rotation of the outer housing 210 with respect to the lower inner housing 220. The outer housing 210 may be rotated in any direction in order to reduce the size of the opening through the inner fluid inlet 222, or to entirely obstruct the inner fluid inlet 222. Adjustment of the outer housing 210 can be manual or automated.

In some embodiments, the portion of the outer housing 210 at the location of the middle fluid inlet 216 includes a plurality of slits. The slits are positioned around the entire circumference of the outer housing 210 so that the rotation of the outer housing 210 with respect to the lower inner housing 220 has no effect on the flow of fluid through the middle fluid inlet 216. These slits can reduce the amount of debris that could enter the middle fluid inlet 216.

In other embodiments, the drain apparatus 200 includes a plurality of sensors (not shown) that are configured to detect a plurality of fluid parameters (e.g., flow rate, static pressure, dynamic pressure, temperature, etc.). A controller (not shown) is in wired or wireless communication with the plurality of sensors, such that the plurality of sensors provides sensor data to the controller. The controller is operably coupled to at least one of the outer housing 210, upper inner housing 221 or lower inner housing 220. The controller may receive sensor data, interpret the sensor data, and respond to the sensor data. In an embodiment, this response includes rotating the outer housing 210, in order to increase or decrease the amount of fluid flowing through the inner fluid inlet 222 (e.g., by making the lower fluid inlet 214 not be in alignment with the inner fluid inlet 222), or to obstruct it completely.

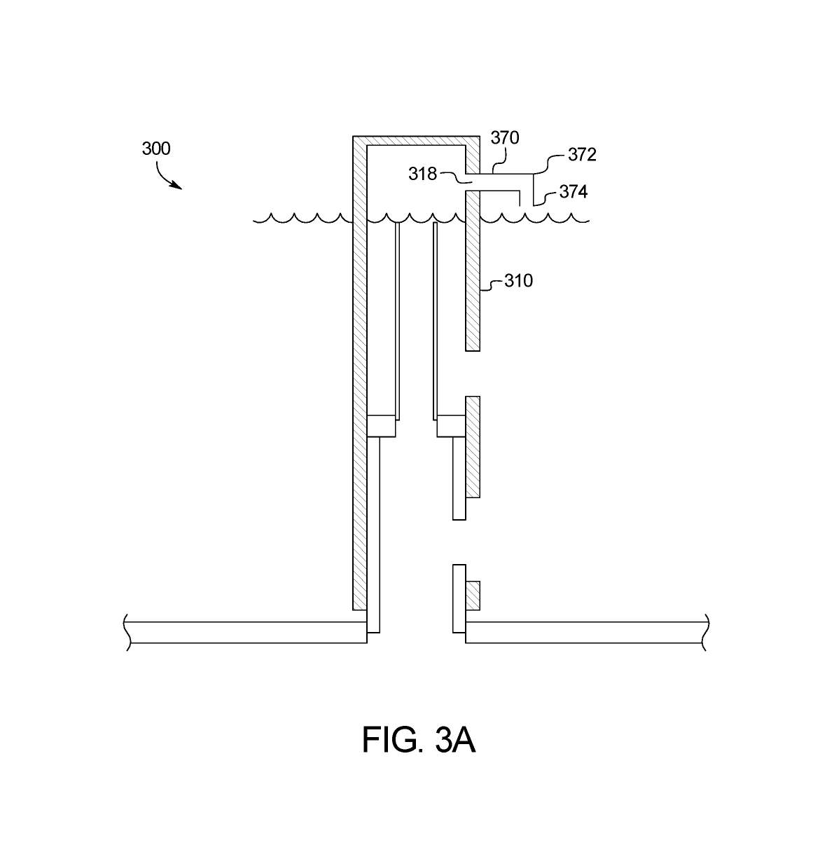

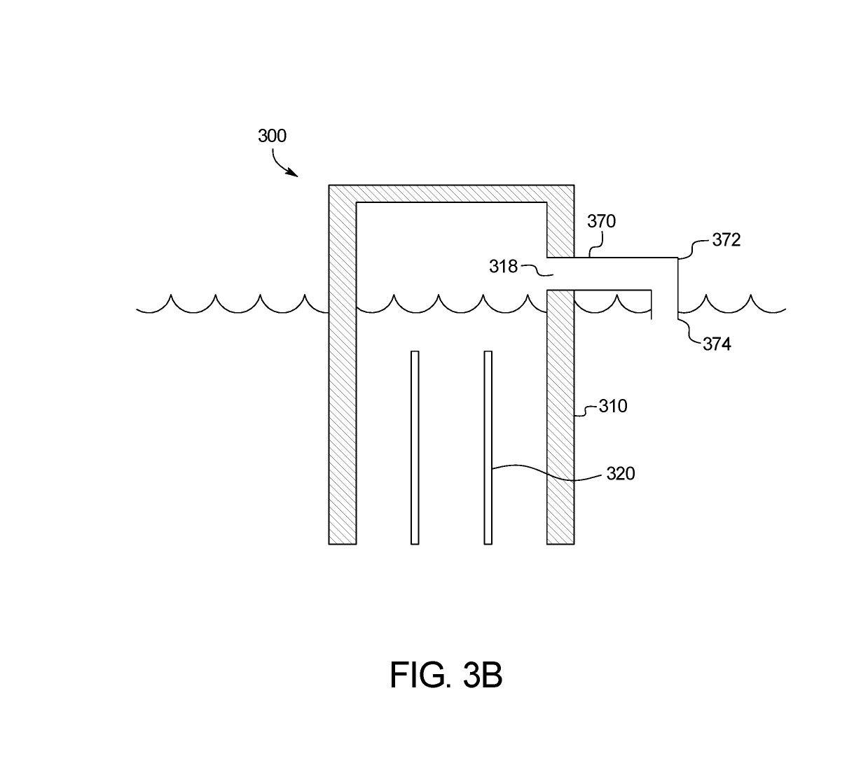

FIG. 3A shows an embodiment of a drain apparatus 300, where an outer housing 310 includes a pipe 370 attached thereto at a position of the upper fluid inlet 318. The pipe 370 has a downward-facing pipe inlet 374. The pipe 370 includes an elbow 372 so that the pipe inlet 374 faces downwards, towards the surface of an external fluid.

FIG. 3B shows an enlarged partial view of an embodiment of a drain apparatus 300, where the upper fluid inlet 318 of the outer housing 310 includes the pipe 370 with the downward-facing pipe inlet 374. When the surface rises to a level at which the pipe inlet 374 is covered (e.g., sealed with water) and the interior of the pipe 370 is evacuated, a siphon effect is established. The siphon effect increases the flow of the fluid through the upper fluid inlet 318, and thereby increases the drain rate of the drain apparatus 300.

FIG. 4 shows an embodiment of a drain apparatus 400, which also includes a blocking member 401 situated inside the lower inner housing 420. The blocking member 401 is positioned inside the lower inner housing 420 and includes a stem 402 that extends up through the upper end of the outer housing 410. In one embodiment, the blocking member 401 is configured to be rotatable inside the lower inner housing 420, wherein the inner fluid inlet 422 may be partially or completely obstructed by the blocking member 401, in order to regulate the flow of fluid through the inner fluid inlet 422, and yet still enable fluid to flow from the secondary chamber 440 out through the drain 412. In an embodiment, the stem 402 is coupled to a transmission module 403. Rotation of the transmission module 403 is transmitted into rotation of the stem 402 and the blocking member 401. In other embodiments, the stem 402 can be omitted, and the blocking member can be rotated or translated up and down through another mechanical means, such as a stepper motor.

In some embodiments, the stem 402 of the blocking member 401 is mechanically coupled to the transmission module 403. In such embodiments, the transmission module 403 is operatively coupled to a controller, which receives sensor data from one or more sensors. The sensors detect at least one fluid parameter (e.g., flow rate, static pressure, dynamic pressure and temperature). The controller is configured to interpret and respond to the sensor data. In an embodiment, the response includes causing the transmission module 403 to rotate the stem 402 and the blocking member 401, in order to regulate fluid flow through the inner fluid inlet 422 (e.g., partial blocking of the inner fluid inlet 422) or to restrict fluid flow entirely (e.g., complete blocking of the inner fluid inlet 422). In an embodiment, the transmission module 403 includes automated means for rotation (e.g., a servo motor).

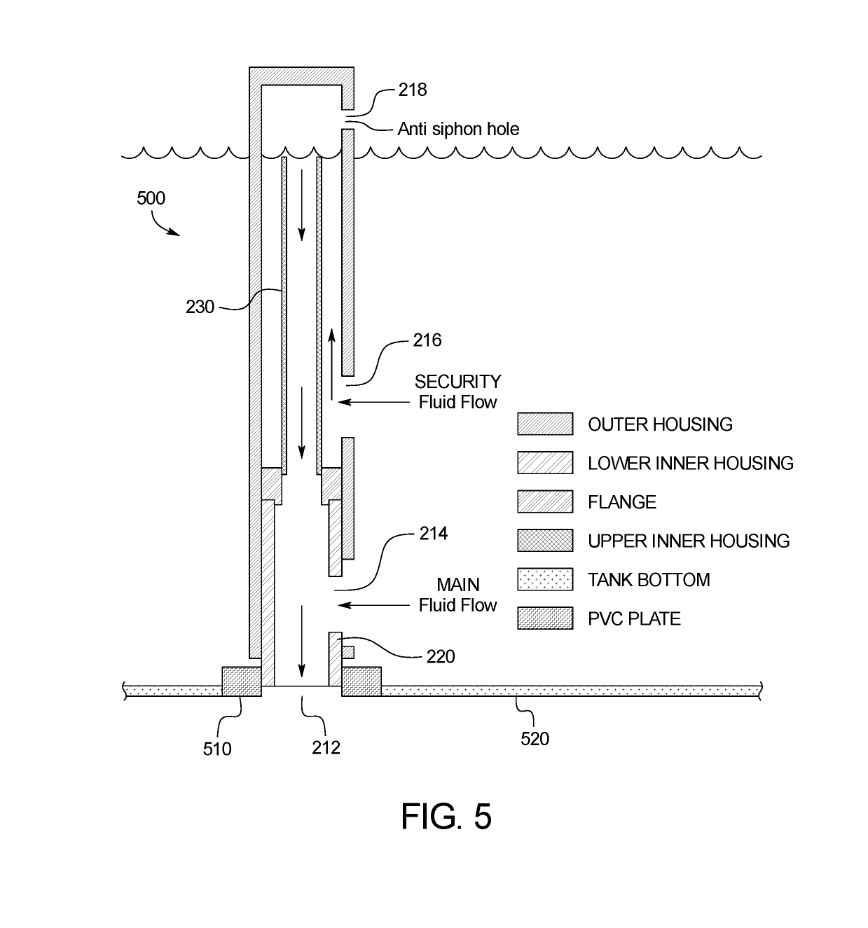

FIG. 5 is a cross sectional view of an embodiment of a drain apparatus 500 comprising an inner housing 220 concentrically arranged within an outer housing 210 and arranged within a PVC plate 510. For example, the drain apparatus 500 includes the outer housing 210, the lower inner housing 220, and the upper inner housing 230. The outer housing 210 has multiple fluid inlets, including at least the drain 212, the lower fluid inlet 214, the middle fluid inlet 216, and the upper fluid inlet 218. The drain apparatus 500 is arranged within a PVC plate 510, and configured to be placed on the bottom of a tank 520.

FIGS. 6A and 6B are three-dimensional views of an embodiment of a drain apparatus 600, where the outer housing includes blocking members 611. For example, the drain apparatus 600 includes the outer housing 610, and the lower inner housing 620. The outer housing 620 has multiple fluid inlets, including at least the drain 612 and the lower fluid inlet 614. In this example, blocking members 611 are formed across the lower fluid inlet 614. The blocking members 611 enable the flow of a fluid through the respective fluid inlet (e.g., the lower fluid inlet 614) while blocking foreign objects, such as small particles, pebbles, etc., from entering into the drain apparatus 600 and subsequently blocking the drain 612, and/or damaging the drain apparatus 600.

In one example, as shown in FIG. 6A, the blocking members 611 are ribs extending across the fluid inlet (e.g., lower fluid inlet 614). The blocking members also function to restrict fluid flow rates. In the example shown in FIGS. 6A and 6B, the outer housing 610 is rotatable with respect to the inner lower housing 620 (see also, FIG. 11A). Thus, if the outer housing 610 is rotated so that the lower fluid inlet 614 having the associated blocking members 611 is not aligned with the inner fluid inlet 622, fluid flow of the main fluid flow path would stop. In this example, even if the main fluid flow were stopped in this manner, fluid flow would still be possible through the secondary fluid flow path (as described above with reference to FIG. 2).

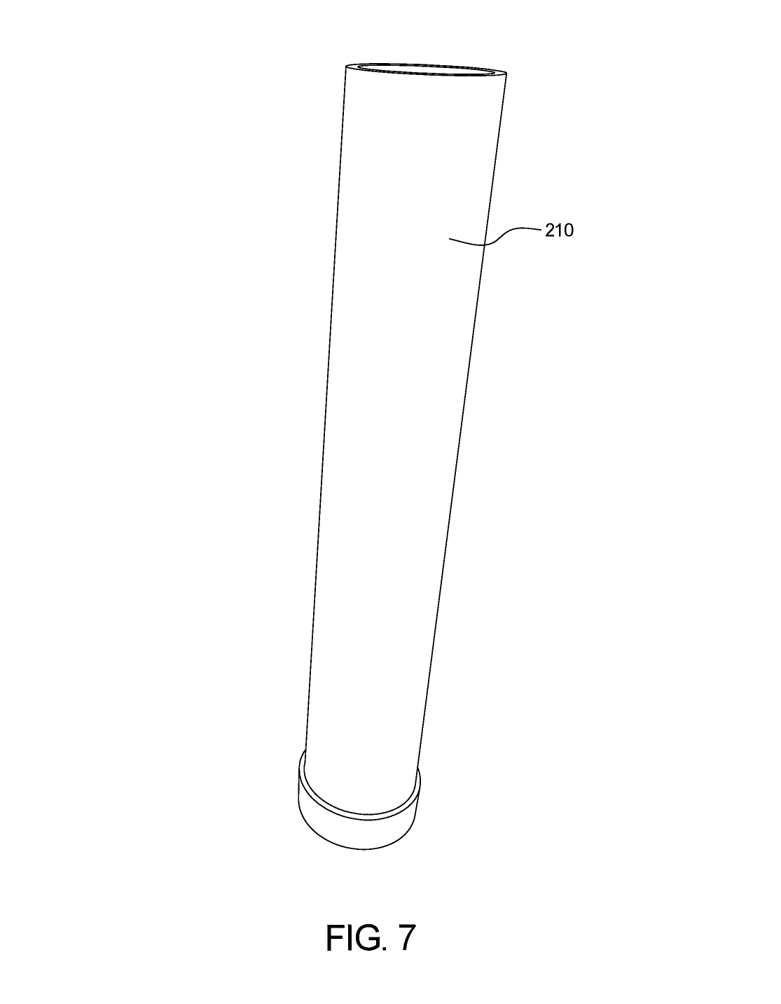

FIG. 7 shows an embodiment of the outer housing 210 (e.g., outer pipe).

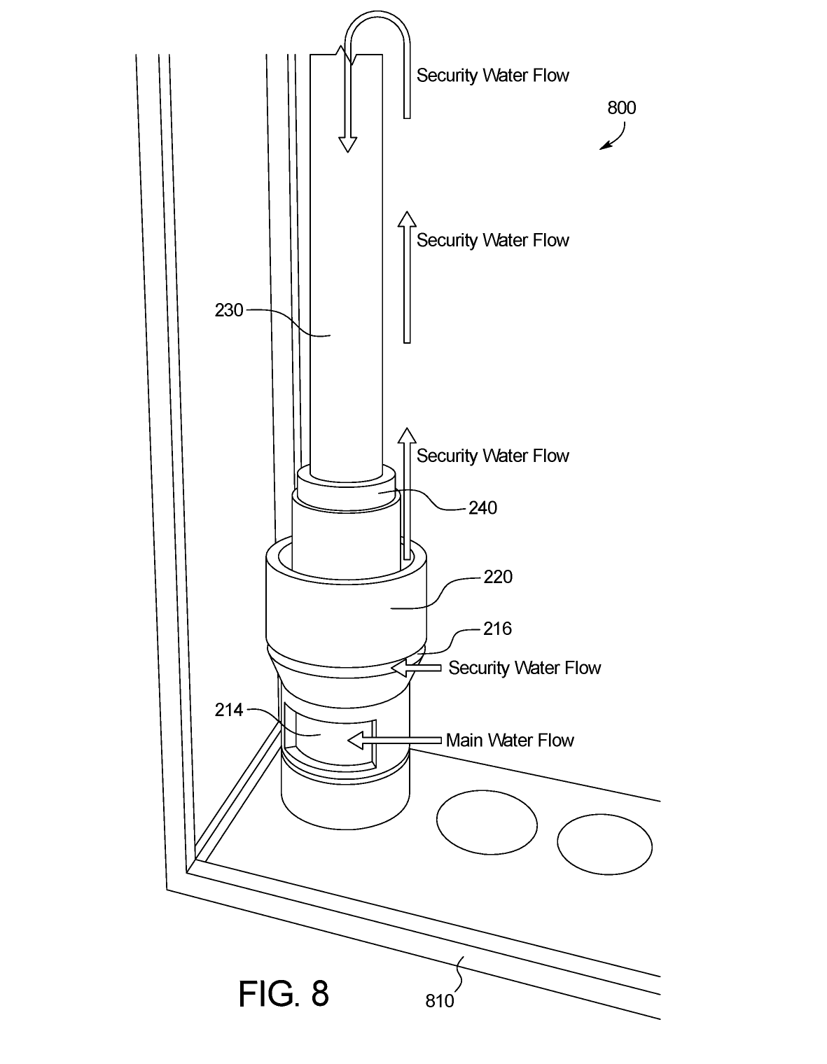

FIG. 8 is a view of an embodiment of a partially assembled drain apparatus 800 including the upper inner housing 230 (e.g., security pipe), lower inner housing 220, and the flange 240. The drain apparatus 800 also includes the lower fluid inlet 214 (e.g., configured for main flow) and the middle fluid inlet 216 (e.g., configured for security water flow). In an embodiment, the drain apparatus 800 is positioned within an aquarium tank 810.

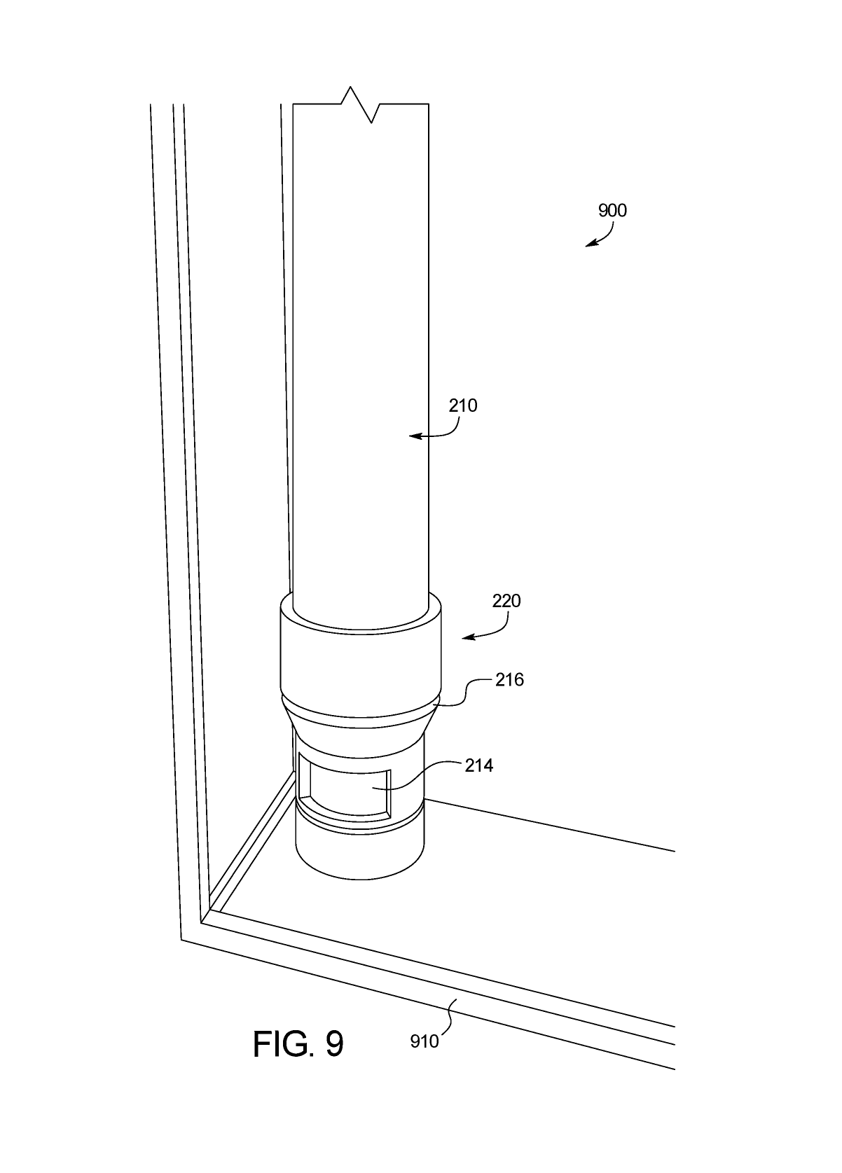

FIG. 9 is a view of an embodiment of a fully assembled drain apparatus 900 including the outer housing 210 (e.g., outer pipe) and the lower inner housing 220. The outer housing 210 is concentric around the outside of the upper inner housing 230 (see e.g., FIG. 8). The drain apparatus 900 also includes the lower fluid inlet 214 and the middle fluid inlet 216. In an embodiment, the drain apparatus 900 is positioned within an aquarium tank 910.

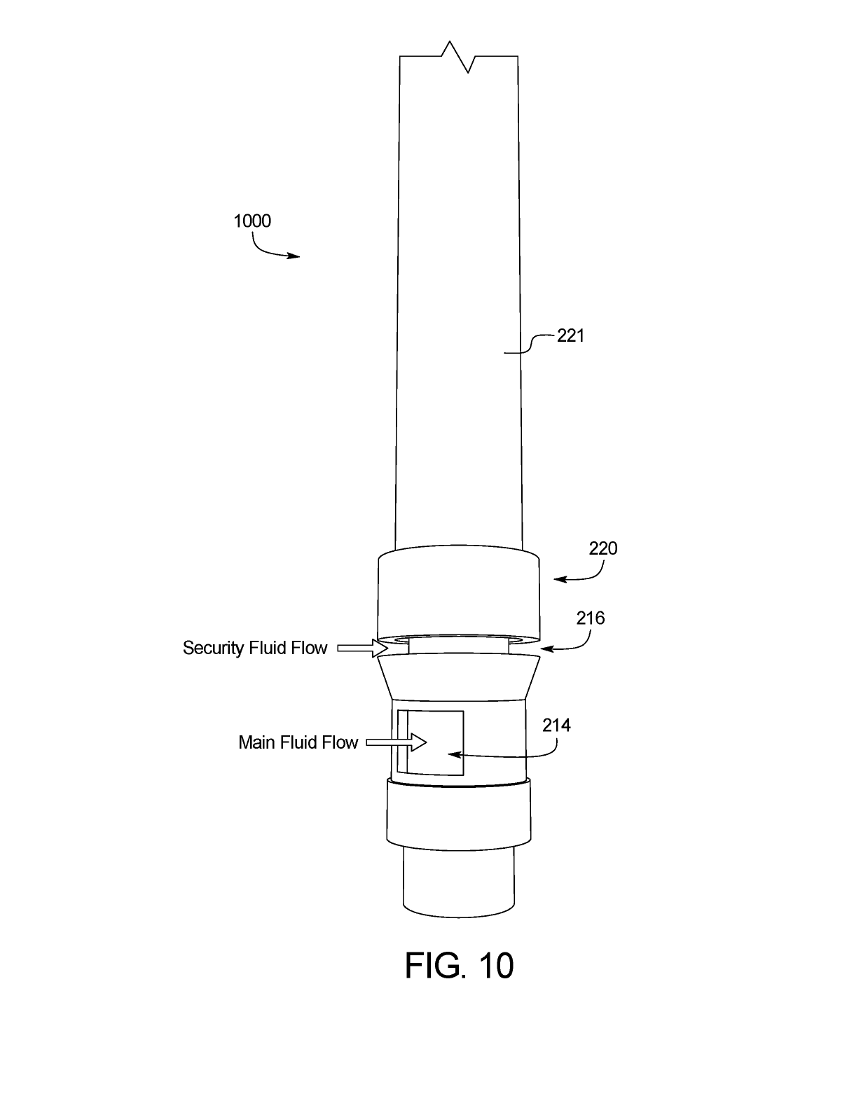

FIG. 10 is an enlarged and rotated view of the embodiment of the fully assembled drain apparatus 1000 shown in FIG. 9, that includes the outer housing 210 (e.g., outer pipe) and the lower inner housing 220 (e.g., inner pipe). FIG. 10 shows more clearly the annular shaped security fluid flow path that allows the fluid to enter the middle fluid inlet 216 and travel upward through the lower inner housing 220 and outside of the upper inner housing 221 (e.g., the weir). The outer housing 210 is concentric with respect to the outside of the upper inner housing 221. The drain apparatus 1000 thus includes the lower fluid inlet 214 (e.g., configured for main flow) and the middle fluid inlet 216 (e.g., configured for security flow). In an embodiment, the drain apparatus 1000 is positioned within an aquarium tank.

FIGS. 11A and 11B are three-dimensional views of an embodiment of a drain apparatus 1100. In this embodiment, the drain apparatus 1100 includes the outer housing 210, the upper inner housing 230, and the lower inner housing 220 (see, FIG. 11B). The outer housing 210 is concentric around the outside of the upper inner housing 230. Also, the outer housing 210 is rotatable relative to the upper inner housing 230, and the lower inner housing 220. The drain apparatus 1100 also includes a lower fluid inlet 1114 and a middle fluid inlet 1116. In this embodiment, each of the lower fluid inlet 214 and the middle fluid inlet 216 include blocking members 610. As shown in FIG. 11A, the drain apparatus 1100 includes a cap 1120 that can be attached to an open end top portion of the outer housing 210.

FIG. 12 is an enlarged partial three-dimensional view of the embodiment of the drain apparatus 1200 shown in FIGS. 11A and 11B. In this embodiment, the drain apparatus 1200 includes the outer housing 210 and the middle fluid inlet 216. The middle fluid inlet 216 includes blocking members 610. The cap 1220 can be attached to an open end top portion of the outer housing 210

It will be appreciated that all of the disclosed methods and procedures described herein can be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

As used in this disclosure and the appended claims, the singular forms “a,” “an” and “the” include plural referents unless the context clearly dictates otherwise. Thus, for example, reference to “a widget” or “the widget” includes two or more widgets. The term “and/or” used in the context of “X and/or Y” should be interpreted as “X,” or “Y,” or “X and Y.” Where used herein, the term “example,” followed by a listing of terms, is merely exemplary and illustrative, and should not be deemed to be exclusive or comprehensive.

Numerical adjectives, such as “first” and “second,” are merely used to distinguish components. These numerical adjectives do not imply the presence of other components, a relative positioning, or any chronological implementation. In this regard, the presence of a “second widget” does not imply that a “first widget” is necessarily present. Further in this regard, a “second widget” can be upstream from, downstream from or co-located with a “first widget,” if any; and a “second widget” can be used before, after, or simultaneously with a “first widget,” if any.

The devices disclosed herein may lack any element that is not specifically disclosed herein. Thus, a disclosure of an embodiment using the term “comprising” includes a disclosure of embodiments “consisting essentially of” and “consisting of” the components identified.

Various embodiments of a drain apparatus are disclosed herein, and any embodiment can be combined with any other embodiment unless explicitly and directly stated otherwise.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A drain apparatus comprising:
an outer housing including a drain, a lower fluid inlet, a middle fluid inlet, and an upper fluid inlet, arranged in that order from a lower portion of the outer housing; and
a weir provided in the outer housing that includes a lower weir end positioned between the lower and middle fluid inlets and an upper weir end positioned between the middle and upper fluid inlets, the weir configured to divide an interior of the outer housing into a plurality of flow paths including:
a main fluid flow path in a primary chamber of the outer housing from the lower fluid inlet to the drain, and
a secondary fluid flow path in a secondary chamber of the outer housing from the middle fluid inlet, over the upper weir end, and down to the primary chamber.

2. The drain apparatus of claim 1, further comprising a lower inner housing positioned below the lower weir end and formed inside the outer housing, the lower inner housing having an inner fluid inlet at least partially alignable with the lower fluid inlet of the outer housing, wherein the primary chamber is formed inside the lower inner housing, such that when the inner fluid inlet of the lower inner housing is at least partially aligned with the lower fluid inlet of the outer housing the main fluid flow path extends from the lower fluid inlet, to the inner fluid inlet, through the lower inner housing, and to the drain.

3. The drain apparatus of claim 2, wherein the weir forms an upper inner housing arranged inside the outer house and in fluid communication with the lower inner housing, the upper inner housing configured such that the secondary fluid flow path extends from the middle fluid inlet, over the upper weir end into an interior of the upper inner housing, and down to the primary chamber.

4. The drain apparatus of claim 3, further comprising a flange disposed between the lower inner housing and the upper inner housing, and between the lower and middle fluid inlets.

5. The drain apparatus of claim 3, wherein a cross-sectional area of the upper inner housing is less than a cross-sectional area of the lower inner housing.

6. The drain apparatus of claim 5, wherein the upper inner housing is coupled with the lower inner housing via the flange.

7. The drain apparatus of claim 2, wherein the outer housing is rotatably coupled with the lower inner housing.

8. The drain apparatus of claim 1, further comprising a pipe connected to the outer housing at the upper fluid inlet, the pipe including an elbow projecting downward that includes a pipe fluid inlet,
wherein the pipe is configured to produce a siphoning effect when a level of a fluid surrounding the drain apparatus is at least as high as the pipe fluid inlet.

9. The drain apparatus of claim 2, wherein at least one of the outer housing and the lower inner housing includes at least one blocking member extending across and dividing the inner fluid inlet and lower fluid inlet into a plurality of inlet portions, respectively.

10. The drain apparatus of claim 1, wherein the middle fluid inlet comprises a plurality of slits positioned around the entire perimeter of the outer housing.

11. The drain apparatus of claim 2, wherein the outer housing is rotatably coupled to the lower inner housing, and the positions of the lower fluid inlet and the inner fluid inlet are arranged so that the inner fluid inlet can be at least partially covered by the outer housing when the outer housing is rotated with respect to the lower inner housing.

12. The drain apparatus of claim 2, further comprising:
a sensor configured to detect fluid flow information of the drain apparatus; and
a controller operably connected to the sensor, the controller configured to receive the fluid flow information, and to and to cause the outer housing and the lower inner housing to move relative to one another based on the fluid flow information.

13. The drain apparatus of claim 2, further comprising a blocking member positioned inside and rotatably coupled with the lower inner housing so that the inner fluid inlet may be at least partially obstructed by the blocking member.

14. The drain apparatus of claim 13, wherein the blocking member includes an elongated portion that extends up through an upper end of the outer housing.

15. The drain apparatus of claim 13, further comprising:
a motor operably coupled to the elongated portion of the blocking member;
a sensor configured to detect fluid flow information of the drain apparatus; and
a controller operably connected to the sensor and to the motor, the controller configured to receive the fluid flow information and to cause the motor to rotate the blocking member based on the fluid flow information.

16. The drain apparatus of claim 3,
wherein the upper inner housing and the outer housing are concentrically arranged pipes, and
wherein a diameter of the upper inner housing is less than a diameter of the outer housing so that an annular fluid flow region exists therebetween and which is part of the secondary fluid flow path in the secondary chamber.
